(19) United States
(12) Patent Application Publication
(10) Pub. No.: US 2010/0111290 A1
(43) Pub. Date: May 6, 2010

(54) Call Voice Processing Apparatus, Call Voice Processing Method and Program

(76) Inventors: Ryuichi NAMBA, Tokyo (JP); Mototsugu Abe, Kanagawa (JP); Masayuki Nishiguchi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/611,908

(22) Filed: Nov. 3, 2009

(30) Foreign Application Priority Data
Nov. 4, 2008 (JP) 2008--283068

(51) Int. Cl. H04M 1/00

(52) U.S. Cl. 379/392.01

(57) ABSTRACT

There is provided a call voice processing apparatus including an input correction unit that corrects characteristics of a first input sound input from a first input apparatus to characteristics of a second input sound input from a second input apparatus, a sound separation unit that separates the second input sound into a plurality of sounds, a sound type estimation unit that estimates sound types of the plurality of sounds separated by the sound separation unit, a mixing ratio calculation unit that calculates a mixing ratio of each sound in accordance with the sound type estimated by the sound type estimation unit, a sound mixing unit that mixes the plurality of sounds separated by the sound separation unit in the mixing ratio calculated by the mixing ratio calculation unit, and an extraction unit that extracts a specific sound from the first input sound corrected by the input correction unit.

### BACKGROUND OF THE INVENTION

1. Field of the Invention

The present invention relates to a call voice processing apparatus, a call voice processing method, and a program, and in particular, relates to a call voice processing apparatus that improves quality of a call voice by utilizing an imaging microphone, a call voice processing method, and a program.

2. Description of the Related Art

Only a single call microphone is normally used in a communication apparatus such as a mobile phone to place a call. Thus, it has been difficult to improve quality by using a plurality of microphones to make use of differences in spatial transfer characteristics. In order to remove noise by using a single voice, there has been no alternative to a technique to add distortion to output sound such as a spectrum subtraction.

Thus, a method of adding a microphone to collect or remove environmental sound is considered to improve quality of a call voice. According to the method, higher quality of a call voice can be realized by subtracting an environmental sound collected by the added microphone from a sound recorded by the call microphone.

Incidentally, communication apparatuses in recent years have increasingly an imaging function. Thus, improving quality of a call voice by utilizing an imaging microphone can be considered realizable without the need to add a microphone as described above. For example, a method of emphasizing only a call voice by separating a sound originating from a plurality of sound sources can be considered. As a method of emphasizing a sound, for example, a method of separating a music signal consisting of a plurality of parts into each part and emphasizing an important part before remixing the separated sound can be considered (for example, Japanese Patent Application Laid-Open No. 2002-236499).

### SUMMARY OF THE INVENTION

However, Japanese Patent Application Laid-Open No. 2002-236499 is intended for a music signal and is not a technology for a call voice. There is also an issue that frequently characteristics of an imaging microphone are significantly different from those of a call microphone and arrangement of each microphone is not necessarily optimized for improvement of quality of a call voice.

The present invention has been made in view of the above issues and it is desirable to provide a novel and improved call voice processing apparatus capable of emphasizing a call voice using microphones of different characteristics, a call voice processing method, and a program.

According to an embodiment of the present invention, there is provided a call voice processing apparatus including an input correction unit that corrects characteristics of a first input sound input from a first input apparatus to characteristics of a second input sound input from a second input apparatus that are different from the characteristics of the first input sound, a sound separation unit that, when a plurality of sounds is contained in the second input sound, separates the second input sound into a plurality of sounds, a sound type estimation unit that estimates sound types of the plurality of sounds separated by the sound separation unit, a mixing ratio calculation unit that calculates a mixing ratio of each sound in accordance with the sound type estimated by the sound type estimation unit, a sound mixing unit that mixes the plurality of sounds separated by the sound separation unit in the mixing ratio calculated by the mixing ratio calculation unit, and an extraction unit that extracts a specific sound from the first input sound corrected by the input correction unit using a mixed sound mixed by the sound mixing unit.

According to the above configuration, characteristics of the first input sound input from the first input apparatus of the call voice processing apparatus are corrected to those of the second input sound input from the second input apparatus. The second input sound is separated into sounds caused by a plurality of sound sources and a plurality of separated sound types is estimated. Then, a mixing ratio of each sound is calculated in accordance with the estimated sound type and each separated sound is remixed in the mixing ratio. Then, a call voice is extracted from the first input sound whose characteristics have been corrected using a mixed sound after being remixed.

Accordingly, a call voice can be emphasized using an input apparatus such as a microphone having different characteristics. That is, a call can be made comfortably by extracting a call voice from the first input sound input into the first input apparatus by utilizing the second input apparatus provided with the call voice processing apparatus. For example, an appropriate call can be prevented from being disabled after a desired call voice is made harder to hear by being masked by noise whose volume is higher than that of the call voice. Also, a call voice desired by the user can be extracted by utilizing the second input apparatus without a microphone to collect or remove an environmental sound being added to the call voice processing apparatus.

The first input apparatus may be a call microphone and the second input apparatus may be an imaging microphone, and the specific sound extracted by the extraction unit may be a voice of a caller.

The sound separation unit may separate the first input sound and the second input sound into a plurality of sounds.

A sound determination unit that determines whether the first input sound contains a voice of a caller may be included.

The sound determination unit may determine whether a sound source of a caller is contained by determining a direction of the sound source, a distance, and a tone using at least one of a volume of the input sound, a spectrum, a phase difference of a plurality of input sounds, and a distribution of amplitude information at discrete times.

The input correction unit may correct frequency characteristics of the first input sound and/or the second input sound.

The input correction unit may perform sampling rate conversions of the first input sound and/or the second input sound.

The input correction unit may correct a delay difference due to A/D conversions of the first input sound and/or the second input sound.

An identity determination unit that determines whether the sounds separated by the sound separation unit are identical among a plurality of blocks, and a recording unit that records the sounds separated by the sound separation unit in units of blocks may be included.

The sound separation unit may separate the input sound into a plurality of sounds using statistical independence of sound and differences in spatial transfer characteristics.

The sound separation unit may separate the input sound into a sound originating from a specific sound source and other sounds using a paucity of overlapping between time-frequency components of sound sources.

The sound type estimation unit may estimate whether the input sound is a steady sound or non-steady sound using a distribution of amplitude information, direction, volume, zero crossing number and the like at discrete times of the input sound.

The sound type estimation unit may estimate whether the sound estimated to be a non-steady sound is a noise sound or a voice uttered by a person.

The mixing ratio calculation unit may calculate a mixing ratio that does not significantly change the volume of the sound estimated to be a steady sound by the sound type estimation unit.

The mixing ratio calculation unit may calculate a mixing ratio that lowers the volume of the sound estimated to be a noise sound by the sound type estimation unit and does not lower the volume of the sound estimated to be a voice uttered by a person.

According to another embodiment of the present invention, there is provided a call voice processing method including the steps of correcting characteristics of a first input sound input from a first input apparatus to characteristics of a second input sound input from a second input apparatus that are different from the characteristics of the first input sound, when a plurality of sounds is contained in the second input sound, separating the second input sound into a plurality of sounds, estimating sound types of the plurality of separated sounds calculating a mixing ratio of each sound in accordance with the estimated sound type, mixing the plurality of separated sounds in the calculated mixing ratio, and extracting a specific sound from the corrected first input sound using a mixed sound obtained by the mixing.

According to another embodiment of the present invention, there is provided a program for causing a computer to function as a call voice processing apparatus including an input correction unit that corrects characteristics of a first input sound input from a first input apparatus to characteristics of a second input sound input from a second input apparatus that are different from the characteristics of the first input sound, a sound separation unit that, when a plurality of sounds is contained in the second input sound, separates the second input sound into a plurality of sounds, a sound type estimation unit that estimates sound types of the plurality of sounds separated by the sound separation unit, a mixing ratio calculation unit that calculates a mixing ratio of each sound in accordance with the sound type estimated by the sound type estimation unit, a sound mixing unit that mixes the plurality of sounds separated by the sound separation unit in the mixing ratio calculated by the mixing ratio calculation unit, and an extraction unit that extracts a specific sound from the first input sound corrected by the input correction unit using a mixed sound mixed by the sound mixing unit.

According to the present invention, as described above, a call voice can be emphasized using microphones of different characteristics.

### BRIEF DESCRIPTION OF THE DRAWINGS

FIG. 1 is a block diagram showing a functional configuration of a call voice processing apparatus according to a first embodiment of the present invention;

FIG. 2 is a functional block diagram showing the configuration of a sound type estimation unit according to the embodiment;

FIG. 3 is an explanatory view showing a state that a sound source position of input sound is estimated based on a phase difference of two input sounds;

FIG. 4 is an explanatory view showing a state that a sound source position of input sound is estimated based on a phase difference of three input sounds;

FIG. 5 is an explanatory view showing a state that a sound source position of input sound is estimated based on a volume of two input sounds;

FIG. 6 is an explanatory view showing a state that a sound source position of input sound is estimated based on a volume of three input sounds;

FIG. 7 is an explanatory view illustrating an example of extraction of a call voice by an extraction unit according to the embodiment;

FIG. 8 is a flow chart showing the flow of a call voice processing method executed by the call voice processing apparatus according to the embodiment; and

FIG. 9 is a block diagram showing the functional configuration of the call voice processing apparatus according to a second embodiment of the present invention.

### DETAILED DESCRIPTION OF EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

“DETAILED DESCRIPTION OF EMBODIMENT” will be described in the order shown below:

[1] Purpose of the embodiment
[2] Description of the call voice processing apparatus according to a first embodiment of the present invention
[2-1] Functional configuration of the call voice processing apparatus according to the present embodiment
[2-2] Operation of the call voice processing apparatus according to the present embodiment
[3] Description of the call voice processing apparatus according to a second embodiment of the present invention
[3-1] Functional configuration of the call voice processing apparatus according to the present embodiment

[1] Purpose of the Embodiments

First, the purpose of the embodiments of the present invention will be described. Only a single call microphone is normally used in a communication apparatus such as a mobile phone to place a call. Thus, it has been difficult to improve quality by using a plurality of microphones to make use of differences in spatial transfer characteristics. In order to remove noise by using a single voice, there has been no alternative to a technique to add distortion to output sound such as a spectrum subtraction.

Thus, a method of adding a microphone to collect or remove environmental sound is considered to improve quality of a call voice. According to the method, higher quality of a call voice can be realized by subtracting an environmental sound collected by the added microphone from a sound recorded by the call microphone.

Incidentally, communication apparatuses in recent years have increasingly an imaging function. Thus, improving quality of a call voice by utilizing an imaging microphone can be considered realizable without the need to add a microphone as described above. For example, a method of separating sounds originating from a plurality of sound sources to emphasize a call voice only can be considered.

However, there is an issue that characteristics of an imaging microphone are significantly different from those of a call microphone frequently and arrangement of each microphone is not necessarily optimized for improvement of quality of a call voice. Thus, with the above situation being focused on, a call voice processing apparatus according to an embodiment of the present invention has been developed. According to a call voice processing apparatus 10 in the embodiments, a call voice can be emphasized using microphones of different characteristics.

[2] Description of the Call Voice Processing Apparatus According to a First Embodiment of the Present Invention

Next, as an example of the call voice processing apparatus according to the present embodiment, the functional configuration and operation of the call voice processing apparatus 10 will be described.

[2-1] Functional Configuration of the Call Voice Processing Apparatus According to the Present Embodiment

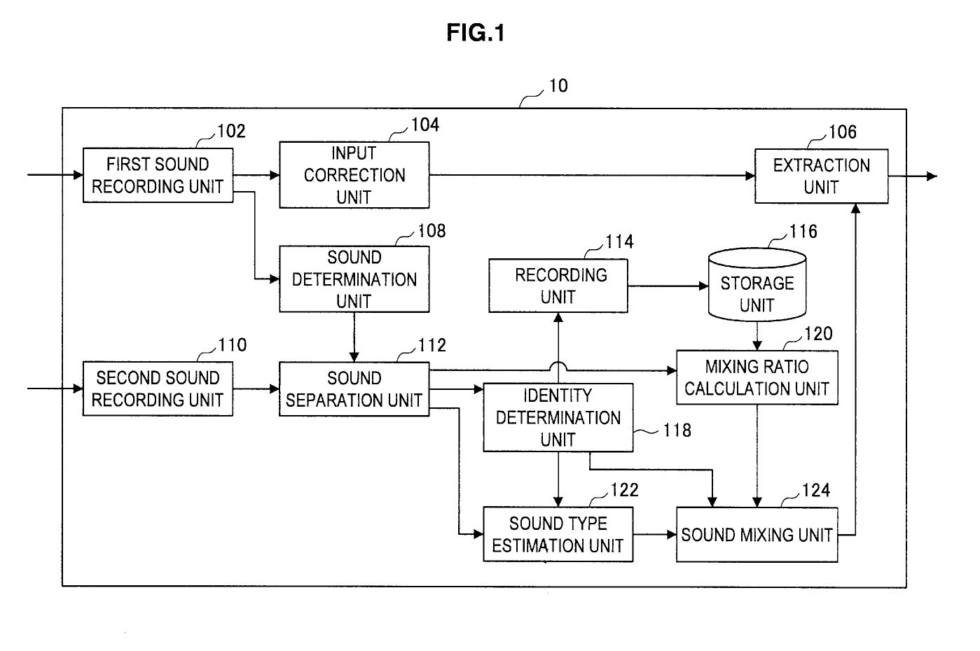

The functional configuration of the call voice processing apparatus 10 will be described with reference to FIG. 1. The call voice processing apparatus 10 according to the present embodiment can, as described above, emphasize a call voice using microphones of different characteristics. As the call voice processing apparatus 10, for example, a communication apparatus such as a mobile phone having an imaging camera can be exemplified.

When a call is made using a communication apparatus having a calling function and an imaging function, a voice uttered by a speaker is frequently masked by a sound caused by another sound source so that the voice uttered by the speaker may not be articulately transmitted. Also when surrounding circumstances change such as when moving, great fluctuations are present in a call voice, making the receiving side difficult to comfortably listen to the call voice at a constant reproduction volume. However, according to the call voice processing apparatus 10 in the present embodiment, an imaging microphone is utilized as a call microphone and improvement of quality of a call voice is enabled by adjusting the volume balance between a call voice and other sound than the call voice or adjusting the level of call volume.

FIG. 1 is a block diagram showing the functional configuration of the call voice processing apparatus 10 according to the present embodiment. As shown in FIG. 1, the call voice processing apparatus 10 includes a first sound recording unit 102, an input correction unit 104, an extraction unit 106, a sound determination unit 108, a second sound recording unit 110, a sound separation unit 112, a recording unit 114, a storage unit 116, an identity determination unit 118, a sound type estimation unit 122, a mixing ratio calculation unit 120, and a sound mixing unit 124.

The first sound recording unit 102 has a function to record sound and to discretely quantize the recorded sound. The first sound recording unit 102 is an example of a first input apparatus of the present invention and, for example, a call microphone. The first sound recording unit 102 contains two or more physically separated recording units (for example, microphones). The first sound recording unit 102 may contain two recording units, one for recording a left sound and the other for recording a right sound.

The first sound recording unit 102 provides the discretely quantized sound to the input correction unit 104 as an input sound. The first sound recording unit 102 may provide the input sound to the sound determination unit 108. The first sound recording unit 102 may provide the input sound in units of blocks of a predetermined length to the input correction unit 104 and/or the sound determination unit 108.

The input correction unit 104 has a function to correct characteristics of the call microphone having different characteristics. That is, characteristics of a first input sound (call voice) input from the call microphone, which is the first input apparatus, are corrected to those of a second input sound (sound during imaging) input from the imaging microphone, which is the second input apparatus. Correcting an input sound is, for example, to perform rate conversions when a sampling frequency is different from that of the other microphone and to apply inverse characteristics of frequency characteristics when frequency characteristics are different. If the amount of delay due to A/D conversion and the like is different, the amount of delay may be corrected.

The sound determination unit 108 has a function to determine whether a voice of caller is contained in the first input sound (call voice) provided by the first sound recording unit 102. More specifically, the sound determination unit 108 determines whether input of voice uttered by a caller is contained after determining whether there is voice input based on the volume of the first input sound, spectra, phase difference information of a plurality of input sounds, and distribution of amplitude information at discrete times. If, as a result of determination, the sound determination unit 108 determines that input of voice uttered by a caller is contained, the sound determination unit 108 notifies the sound separation unit 112 of the determination result.

The second sound recording unit 110 has a function to record sound and to discretely quantize the recorded sound. The second sound recording unit 110 is an example of the second input apparatus of the present invention and, for example, an imaging microphone. The second sound recording unit 110 contains two or more physically separated recording units (for example, microphones). The second sound recording unit 110 may contain two recording units, one for recording a left sound and the other for recording a right sound. The second sound recording unit 110 provides the discretely quantized sound to the sound separation unit 112 as an input sound. The second sound recording unit 110 may provide the input sound to the sound separation unit 112 in units of blocks of a predetermined length.

The sound separation unit 112 has a function to separate the second input sound provided by the second sound recording unit 110 into a plurality of sounds caused by a plurality of sound sources. More specifically, the second input sound is separated using statistical independence of sound sources and differences in spatial transfer characteristics. When an input sound is provided by the second sound recording unit 110 in units of blocks of a predetermined length, as described above, the sound may be separated in units of the blocks.

As a concrete technique to separate sound sources by the sound separation unit 112, for example, a technique using the independent component analysis (article 1: Y. Mori, H. Saruwatari, T. Takatani, S. Ukai, K. Shikano, T. Hietaka, T. Morita, Real-Time Implementation of Two-Stage Blind Source Separation Combining SIMO-ICA and Binary Masking, Proceedings of IWAENC2005, (2005)) may be used. A technique that uses a paucity of overlapping between time-frequency components of sound (article 2: O. Yilmaz and S. Richard, Blind Separation of Speech Mixtures via Time-Frequency Masking, IEEE TRANSACTIONS ON SIGNAL PROCESSING, VOL. 52, NO. 7, JULY (2004)) may also be used.

The first input sound may be separated when a result of determination by the sound determination unit 108 that a voice uttered by a caller is contained is notified. The first input sound may be prevented from being separated when a result of determination by the sound determination unit 108 that no voice uttered by a caller is contained is notified.

While the first input sound is determined by the sound determination unit 108 in the present embodiment, a configuration in which the function of the sound determination unit 108 is omitted may be adopted. That is, the first input sound may all be provided to the sound separation unit 112 without the first input sound being determined.

The identity determination unit 118 has a function, when an input sound is separated into a plurality of sounds in units of blocks by the sound separation unit 112, to determine whether the separated sounds are identical among a plurality of blocks. The identity determination unit 118 determines whether separated sounds between consecutive blocks originate from the same sound source using, for example, the distribution of amplitude information, volume, direction information and the like at discrete times of separated sounds provided by the sound separation unit 112.

The recording unit 114 has a function to record volume information of sounds separated by the sound separation unit 112 in the storage unit 116 in units of blocks. Volume information recorded in the storage unit 116 includes, for example, sound type information of each separated sound acquired by the identity determination unit 118 and the average value, maximum value, variance and the like of separated sounds acquired by the sound separation unit 112. In addition to real-time sound, the average value of volume of separated sounds on which sound processing was performed in the past may be recorded. If volume information of input sound is available prior to the input sound, the volume information may be recorded.

The sound type estimation unit 122 has a function to estimate the sound type of a plurality of sounds separated by the sound separation unit 112. The sound type (steady or non-steady, noise or sound) is estimated, for example, from sound information obtained from the volume of separated sound and the distribution, maximum value, average value, variance, zero crossing number and the like of amplitude information, and direction distance information. Here, detailed functions of the sound type estimation unit 122 will be described. A case in which the call voice processing apparatus 10 is mounted in a communication apparatus will be described below. The sound type estimation unit 122 determines whether any sound originating from the neighborhood of the imaging apparatus such as a voice of an operator of the imaging apparatus or noise resulting from an operation of the operator is contained. Accordingly, by which sound source a sound is caused can be estimated.

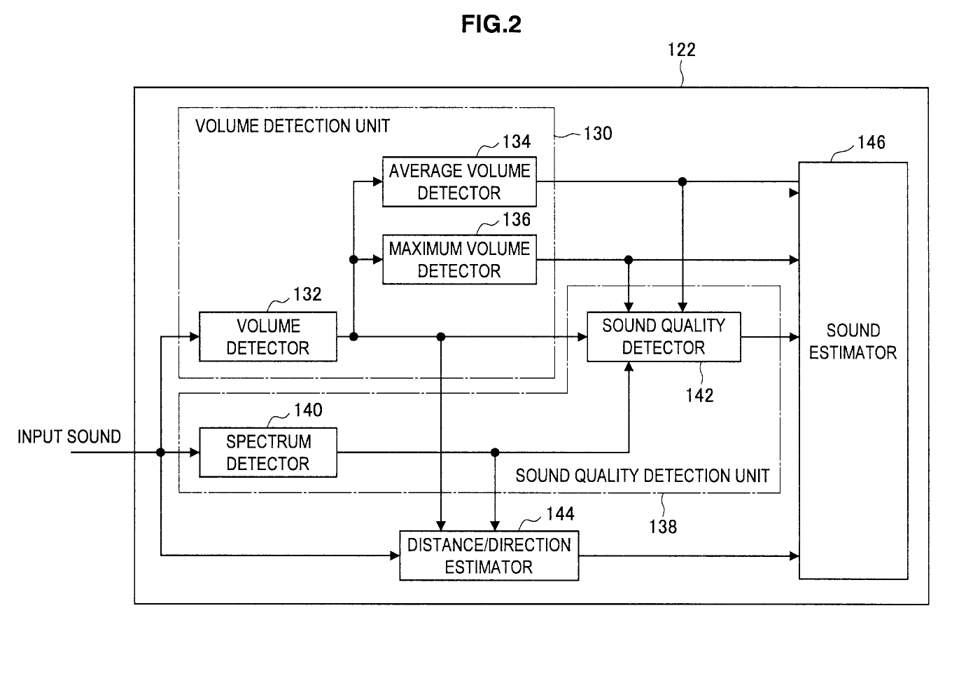

FIG. 2 is a functional block diagram showing the configuration of the sound type estimation unit 122. The sound type estimation unit 122 includes a volume detection unit 130 including a volume detector 132, an average volume detector 134, and a maximum volume detector 136, a sound quality detection unit 138 including a spectrum detector 140 and a sound quality detector 142, a distance/direction estimator 144, and a sound estimator 146.

The volume detector 132 detects a volume value sequence (amplitude) of input sound given in frames of a predetermined length (for example, several tens msec) and outputs the detected volume value sequence of input sound to the average volume detector 134, the maximum volume detector 136, the sound quality detector 142, and the distance/direction estimator 144.

The average volume detector 134 detects the average value of volume of input sound, for example, in frames based on the volume value sequence in frames input from the volume detector 132. The average volume detector 134 outputs the detected average value of volume to the sound quality detector 142 and the sound estimator 146.

The maximum volume detector 136 detects the maximum value of volume of input sound, for example, in frames based on the volume value sequence in frames input from the volume detector 132. The maximum volume detector 136 outputs the detected maximum value of volume of input sound to the sound quality detector 142 and the sound estimator 146.

The spectrum detector 140 detects each spectrum in the frequency domain of input sound by performing, for example, FFT (Fast Fourier Transform) on the input sound. The spectrum detector 140 outputs detected spectra to the sound quality detector 142 and the distance/direction estimator 144.

The sound quality detector 142 has an input sound, average value of volume, maximum value of volume, and spectrum input thereinto, detects a likeness of human voice, that of music, steadiness, and impulse property of the input sound, and outputs detection results to the sound estimator 146. The likeness of human voice may be information indicating whether a portion or all of the input sound matches human voice or to which extent the input sound resembles human voice. Also, the likeness of music may be information indicating whether a portion or all of the input sound matches music or to which extent the input sound resembles music.

Steadiness indicates, for example, like an air-conditioning sound, a property whose statistical property of sound does not change significantly over time. The impulse property indicates, for example, like a blow sound or plosive, a property full of noise in which energy is concentrated in a short period of time.

The sound quality detector 142 can detect, for example, a likeness of human voice based on the degree of matching of the spectral distribution of input sound and that of human voice. The sound quality detector 142 may also detect a higher impulse property with an increasing maximum value of volume by comparing maximum values of volume of each frame or other frames.

The sound quality detector 142 may analyze sound quality of input sound using signal processing technology such as the zero crossing method and LPC (Linear Predictive Coding) analysis. According to the zero crossing method, a fundamental period of input sound is detected and therefore, the sound quality detector 142 may detect a likeness of human voice based on whether the fundamental period is contained in the fundamental period (for example, 100 to 200 Hz) of human voice.

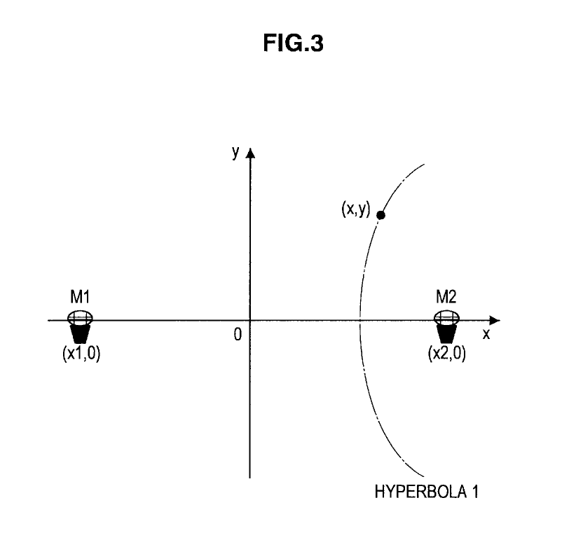

The distance/direction estimator 144 has an input sound, volume value sequence of the input sound, spectrum of the input sound and the like input thereinto. The distance/direction estimator 144 has a function, based on the input, as a positional information calculation unit that estimates the sound source of the input sound or positional information such as direction information and distance information of the sound source from which a dominant sound contained in the input sound originates. The distance/direction estimator 144 can collectively estimate the position of the sound source even if a reverberation or the reflection of sound caused by the main body of imaging apparatus has a great influence by combining the phase, volume, and volume value sequence of input sound and estimation methods of positional information of the sound source based on the average volume value and maximum volume value in the past. An example of the estimation method of the direction information and distance information by the distance/direction estimator 144 will be described with reference to FIGS. 3 to 6.

FIG. 3 is an explanatory view showing a state that the sound source position of an input sound is estimated based on a phase difference of two input sounds. If the sound source is assumed to be a point sound source, the phase of each input sound reaching a microphone M1 and a microphone M2 constituting the second sound recording unit 110 and a phase difference of the input sounds can be measured. Further, a difference between the distance from the microphone M1 to the sound source position of input sound and that from the microphone M2 can be calculated from the phase difference and values of a frequency f and a sound velocity c of the input sound. The sound source is present on a set of points where the difference of distance is constant. It is known that such a set of points where the difference of distance is constant forms a hyperbola.

It is assumed, for example, that the microphone M1 is positioned at (x1, 0) and the microphone M2 at (x2, 0) (generality is not lost under this assumption). If a point on a set of the sound source position to be determined is at (x, y) and the difference of distance is d, Formula 1 shown below holds:

[Equation 1]

\sqrt{(x−x₁)²}−\sqrt{(x−x₂)+y²}=d (Formula 1)

Further, Formula 1 can be expanded into Formula 2, from which Formula 3 representing a hyperbola is derived:

$$\begin{matrix} ( Formula 2 ) \\ {\{ {( x - {x}_{1} )}^{2} + 2 {y}^{2} + {( x - {x}_{2} )}^{2} - {d}^{2} \}}^{2} = 4 \{ {( x - {x}_{1} )}^{2} + {y}^{2} \} \{ {( x - {x}_{2} )}^{2} + {y}^{2} \} \\ & [ Equation 2 ] \\ ( Formula 3 ) \\ \frac{{( x - \frac{{x}_{1} + {x}_{2}}{2} )}^{2}}{{( \frac{d}{2} )}^{2}} - \frac{{y}^{2}}{{( \frac{1}{2} )}^{2}} = 1 & [ Equation 3 ]\end{matrix}$$

The distance/direction estimator 144 can also determine to which of the microphone M1 and the microphone M2 the distance/direction estimator 144 is closer based on a volume difference between input sounds recorded by the microphone M1 and the microphone M2. Accordingly, for example, as shown in FIG. 3, the sound source can be determined to be present on a hyperbola 1 closer to the microphone M2.

Incidentally, it is necessary for the frequency f of input sound used for calculation of a phase difference to satisfy a condition on a distance between the microphone M1 and the microphone M2 in Formula 4:

$$( Formula 4 ) \\ f < \frac{c}{2 d} \qquad [ Equation 4 ]$$

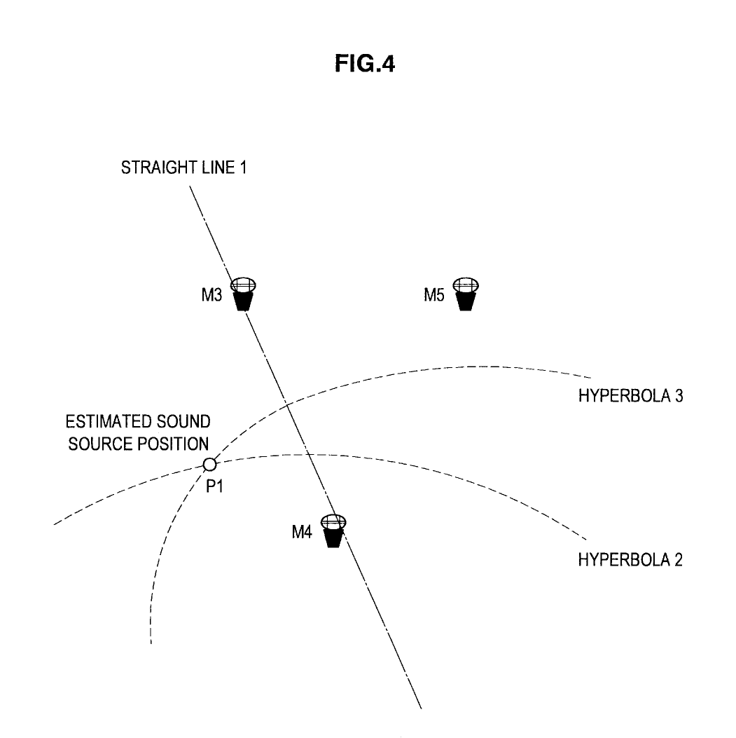

FIG. 4 is an explanatory view showing a state that the sound source position of an input sound is estimated based on phase differences among three input sounds. Arrangement of a microphone M3, a microphone M4, and a microphone M5 constituting the second sound recording unit 110 as shown in FIG. 4 is assumed. The phase of input sound arriving at the microphone M5 may be delayed when compared with that of input sound arriving at the microphone M3 or the microphone M4. In such a case, the distance/direction estimator 144 can determine that the sound source is positioned on the opposite side of the microphone M5 with respect to a straight line 1 linking the microphone M3 and the microphone M4 (front/back determination).

Further, the distance/direction estimator 144 calculates a hyperbola 2 on which the sound source could be present based on a phase difference of input sounds arriving at each of the microphone M3 and the microphone M4. Then, the distance/direction estimator 144 can calculate a hyperbola 3 on which the sound source could be present based on a phase difference of input sounds arriving at each of the microphone M4 and the microphone M5. As a result, the distance/direction estimator 144 can estimate that an intersection P1 of the hyperbola 2 and the hyperbola 3 is the sound source position.

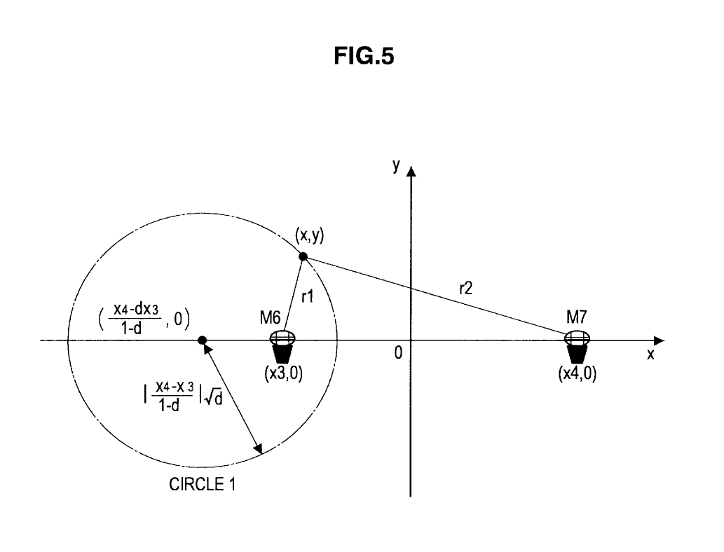

FIG. 5 is an explanatory view showing a state that the sound source position of an input sound is estimated based on volumes of two input sounds. If the sound source is assumed to be a point sound source, the volume measured at a point is inversely proportional to the square of distance based on the inverse square law. If a microphone M6 and a microphone M7 constituting the second sound recording unit 110 as shown in FIG. 5 is assumed, a set of points where the ratio of volumes arriving at the microphone M6 and the microphone M7 is constant forms a circle. The distance/direction estimator 144 can determine the radius and the center position of the circle on which the sound source is present by determining the ratio of volume from values of volume input from the volume detector 132.

It is assumed, as shown in FIG. 5, that the microphone M6 is positioned at (x3, 0) and the microphone M7 at (x4, 0). In this case (generality is not lost under this assumption), if a point on a set of the sound source position to be determined is at (x, y), distances r1 and r2 from each microphone to the sound source can be expressed as Formula 5 below:

[Equation 5]

r₁=\sqrt{(x−x₃)²+y²} r₂=\sqrt{(x−x₄)²+y²} (Formula 5)

Here, Formula 6 below holds thanks to the inverse square law:

$$( Formula 6 ) \\ \frac{1}{{r}_{1}^{2}} : \frac{1}{{r}_{2}^{2}} = constant \qquad [ Equation 6 ]$$

Formula 6 is transformed to Formula 7 using a positive constant d (for example, 4):

$$( Formula 7 ) \\ \frac{{r}_{2}^{2}}{{r}_{1}^{2}} = d \qquad [ Equation 7 ]$$

Formula 8 below is derived by substitution into r1 and r2 in Formula 7:

$$( Formula 8 ) \\ \frac{{( x - {x}_{4} )}^{2} + {y}^{2}}{{( x - {x}_{3} )}^{2} + {y}^{2}} = {d \\ ( x - \frac{{x}_{4} - {dx}_{3}}{1 - d} )}^{2} + {y}^{2} = \frac{{d ( {x}_{4} - {x}_{3} )}^{2}}{{( 1 - d )}^{2}} \qquad [ Equation 8 ]$$

From Formula 8, the distance/direction estimator 144 can estimate that, as shown in FIG. 5, the sound source is present on a circle 1 whose center coordinates are represented by Formula 9 and whose radius is represented by Formula 10.

$$\begin{matrix}( Formula 9 ) \\ ( \frac{{x}_{4} - {dx}_{3}}{1 - d} , 0 ) & [ Equation 9 ] \\ ( Formula 10 ) \\ \vert \frac{{x}_{4} - {x}_{3}}{1 - d} \vert \sqrt{d} & [ Equation 10 ]\end{matrix}$$

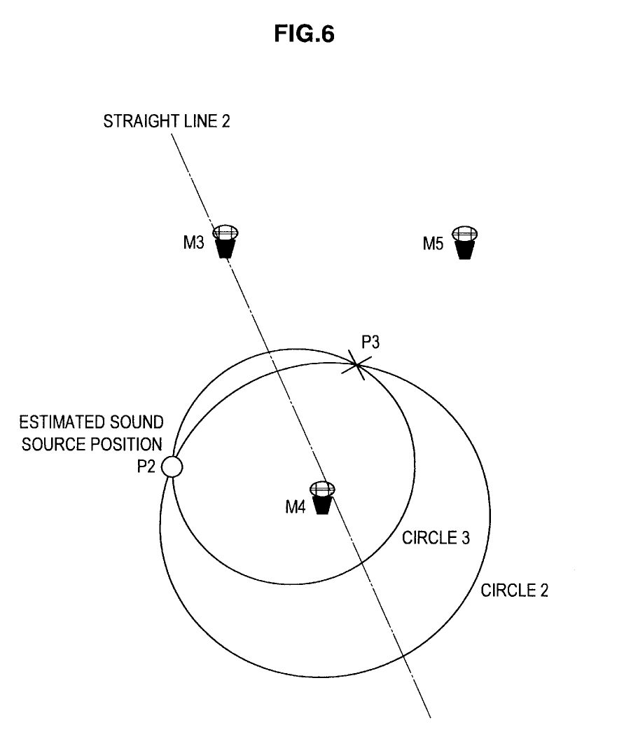

FIG. 6 is an explanatory view showing a state that the sound source position of an input sound is estimated based on volumes of three input sounds. Arrangement of the microphone M3, the microphone M4, and the microphone M5 constituting the second sound recording unit 110 as shown in FIG. 6 is assumed. The phase of input sound arriving at the microphone M5 may be delayed when compared with that of input sound arriving at the microphone M3 or the microphone M4. In such a case, the distance/direction estimator 144 can determine that the sound source is positioned on the opposite side of the microphone M5 with respect to a straight line 2 linking the microphone M3 and the microphone M4 (front/back determination).

Further, the distance/direction estimator 144 calculates a circle 2 on which the sound source could be present based on a volume ratio of input sounds arriving at each of the microphone M3 and the microphone M4. Then, the distance/direction estimator 144 can calculate a circle 3 on which the sound source could be present based on a volume ratio of input sounds arriving at each of the microphone M4 and the microphone M5. As a result, the distance/direction estimator 144 can estimate that an intersection P2 of the circle 2 and the circle 3 is the sound source position. If four or more microphones are used, the distance/direction estimator 144 can estimate more precisely including spatial arrangement of the sound source.

The distance/direction estimator 144 estimates, as described above, the position of the sound source of input sound based on a phase difference or volume ratio of input sounds and outputs direction information or distance information of the estimated sound source to the sound estimator 146. Table 1 below lists the input/output of each component of the volume detection unit 130, the sound quality detection unit 138, and the distance/direction estimator 144 described above.

TABLE 1

| Block | Input | Output |
|---|---|---|
| Volume | Input sound | Volume value sequence |
| detector | | (amplitude) in frame |
| Average | Volume value sequence | Average value of |
| volume | (amplitude) in frame | volume |
| detector | | |
| Maximum | Volume value sequence | Maximum value of |
| volume | (amplitude) in frame | volume |
| detector | | |
| Spectrum | Input sound | Spectrum |
| detector | | |
| Sound | Input sound | Likeness of human |
| quality | Average value of volume | voice |
| detector | Maximum value of volume | Likeness of music |
| | Spectrum | Steady or non-steady |
| | | Impulse property |
| Distance/ | Input sound | Direction information |
| direction | Volume value sequence | Distance information |
| estimator | (amplitude) in frame | |
| | Spectrum | |

If sounds originating from a plurality of sound sources are superimposed on an input sound, it is difficult for the distance/direction estimator 144 to precisely estimate the sound source position of a sound predominantly contained in the input sound. However, the distance/direction estimator 144 can estimate a position close to the sound source position of the sound predominantly contained in the input sound. The estimated sound source position may be used as an initial value for sound separation by the sound separation unit 112 and thus, the call voice processing apparatus 10 can perform a desired operation even if there is an error in the sound source position estimated by the distance/direction estimator 144.

The description of the configuration of the sound type estimation unit 122 will be resumed with reference to FIG. 2. The sound estimator 146 collectively determines whether any neighborhood sound originating from a specific sound source in the neighborhood of the call voice processing apparatus 10 such as a voice of the operator or noise resulting from an operation of the operator is contained in the input sound based on at least one of the volume, sound quality, and positional information of input sound. If the sound estimator 146 determines that a neighborhood sound is contained in the input sound, the sound estimator 146 has a function as a sound determination unit that outputs a message that a neighborhood sound is contained in the input sound (operator voice present information) and positional information estimated by the distance/direction estimator 144 to the sound separation unit 112.

More specifically, if the distance/direction estimator 144 estimates that the position of the sound source of input sound is behind an imaging unit (not shown) imaging video in the imaging direction and the input sound has sound quality that matches or resembles that of human voice, the sound estimator 146 may determine that a neighborhood sound is contained in the input sound.

If the position of the sound source of input sound is behind an imaging unit in the imaging direction and the input sound has sound quality that matches or resembles that of human voice, the sound estimator 146 may determine that the voice of the operator is predominantly contained as a neighborhood sound in the input sound. As a result, a mixed sound in which the sound ratio of the voice of the operator is reduced can be obtained from the sound mixing unit 124 described later.

The sound estimator 146 has the position of the sound source of input sound within the range of a setting distance (neighborhood of the call voice processing apparatus 10, for example, within 1 m of the call voice processing apparatus 10) from the recording position. If the input sound contains an impulse sound and the input sound is higher than an average volume in the past, the sound estimator 146 may determine that the input sound contains a neighborhood sound caused by a specific sound source. Here, an impulse sound such as “click” and “bang” is frequently caused when the operator of an imaging apparatus operates a button of the imaging apparatus or shifts the imaging apparatus from one hand to the other. Moreover, the impulse sound is caused by an imaging apparatus equipped with the call voice processing apparatus 10 and thus, it is highly likely that the impulse sound is recorded at a relatively large volume.

Therefore, the sound estimator 146 has the position of the sound source of input sound within the range of a setting distance from the recording position. If input sound contains an impulse sound and the input sound is higher than an average volume in the past, the input sound can be determined to predominantly contain noise resulting from an operation of the operator as a neighborhood sound. As a result, a mixed sound in which the sound ratio of noise resulting from an operation of the operator is reduced can be obtained from the sound mixing unit 124 described later.

In addition, Table 2 summarizes examples of information input into the sound estimator 146 and determination results of the sound estimator 146 based on the input information. By combining with a proximity sensor, temperature sensor or the like, precision of determination by the sound estimator 146 can be improved.

TABLE 2

| Sound estimator input | | | | | | | | | | |
|---|---|---|---|---|---|---|---|---|---|---|
| | | | Sound quality | | | | | | | |
| Volume | | | Likeness | | | | | | | |
| | Average | Maximum | of human | Likeness | Steady or | Impulse | Direction and distance | | | |
| Volume | volume | volume | voice | of music | non-steady | property | Direction | Distance | Determination results | |
| High | Higher than | High | High | Low | Non-steady | Normal | Behind | Close | Non-steady | Operator voice |
| | average volume | | | | | | main body | | sound | |
| | in the past | | | | | | | | | |
| Medium | Comparatively | Medium | Normal | Normal | Non-steady | Normal | In front of | Close to | | Object sound |
| | higher than | to high | | | | | main body | far | | |
| | average volume | | | | | | | | | |
| | in the past | | | | | | | | | |
| High | Higher than | High | Low | Low | Non-steady | High | All | Close | Non-steady | Operation noise |
| | average volume | | | | | | directions | | noise | |
| | in the past | | | | | | | | | |
| Low | Comparatively | Medium | Low | Low | Non-steady | High | All | Far | | Impulsive |
| | lower than | | | | | | directions | | | environmental |
| | average volume | | | | | | | | | sound |
| | in the past | | | | | | | | | |
| Low | Lower than | Low | Normal | Normal | Steady | Low | Direction | Far | Steady | Environmental |
| | average volume | | | | | | unknown | | noise | sound |
| | in the past | | | | | | | | | |

Returning to FIG. 1, the mixing ratio calculation unit 120 has a function to calculate the mixing ration of each sound in accordance with the sound type estimated by the sound type estimation unit 122. For example, a mixing ratio that lowers the volume of a dominant sound is calculated using separated sounds separated by the sound separation unit 112, sound type information by the sound type estimation unit 122, and volume information recorded in the recording unit 114.

When the sound type is more steady, a mixing ratio so that volume information does not change significantly between consecutive blocks is also calculated with reference to output information of the sound type estimation unit 122. When the sound type is not steady (non-steady) and noise is more likely, the mixing ratio calculation unit 120 lowers the volume of the sound concerned. On the other hand, if the sound type is non-steady a voice uttered by a person is more likely, the volume of the sound concerned is not much lowered when compared with noise sound.

The sound mixing unit 124 has a function to mix a plurality of sounds separated by the sound separation unit 112 in the mixing ratio provided by the mixing ratio calculation unit 120. For example, the sound mixing unit 124 may mix a neighborhood sound of the call voice processing apparatus 10 and a sound to be recorded so that the volume ratio occupied by the neighborhood sound is made lower than that of the neighborhood sound occupied in the input sound. Accordingly, if the volume of neighborhood sound of the first input sound is unnecessarily high, a mixed sound in which the volume ratio occupied by the sound to be recorded is increased from that of the sound to be recorded occupied in the input sound can be obtained. As a result, the sound to be recorded can be prevented from being buried by the neighborhood sound.

The extraction unit 106 has a function to extract a specific sound from the first input sound corrected by the input correction unit 104 using a mixed sound mixed by the sound mixing unit 124. For example, a call voice may be extracted by emphasizing the call voice contained in the first input sound provided by the input correction unit 104.

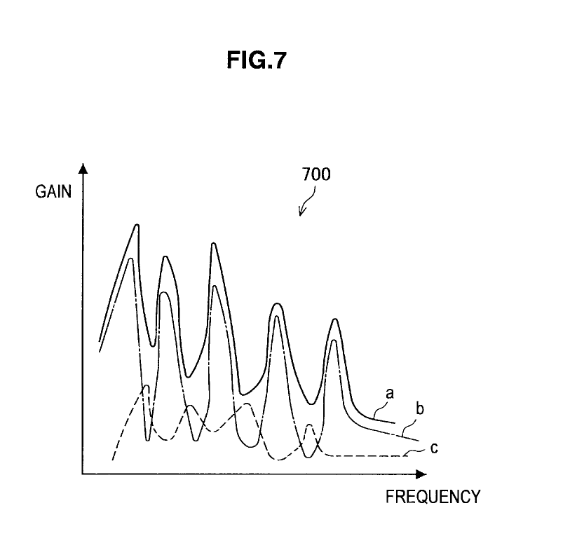

Nonlinear processing such as a spectrum subtraction can be considered as a mechanism of extracting a call voice, the mechanism is not limited to such an example. Here, extraction of a call voice by the extraction unit 106 will be described with reference to FIG. 7. FIG. 7 is an explanatory view illustrating an example of extraction of a call voice by the extraction unit 106.

As shown in FIG. 7, frequency characteristics a shown in a graph 700 are frequency characteristics of a sound in which a call voice dominates. Frequency characteristics b are frequency characteristics of a sound in which a noise sound dominates. Then, frequency characteristics c show a sound in which a call voice is emphasized.

The extraction unit 106 extracts a sound in which a call voice is emphasized indicated by the frequency characteristics c by subtracting characteristics of a sound in which a noise sound indicated by the frequency characteristics b dominates from characteristics of a sound in which a call voice indicated by the frequency characteristics a dominates.

### [2-2] Operation of the Call Voice Processing Apparatus According to the Present Embodiment

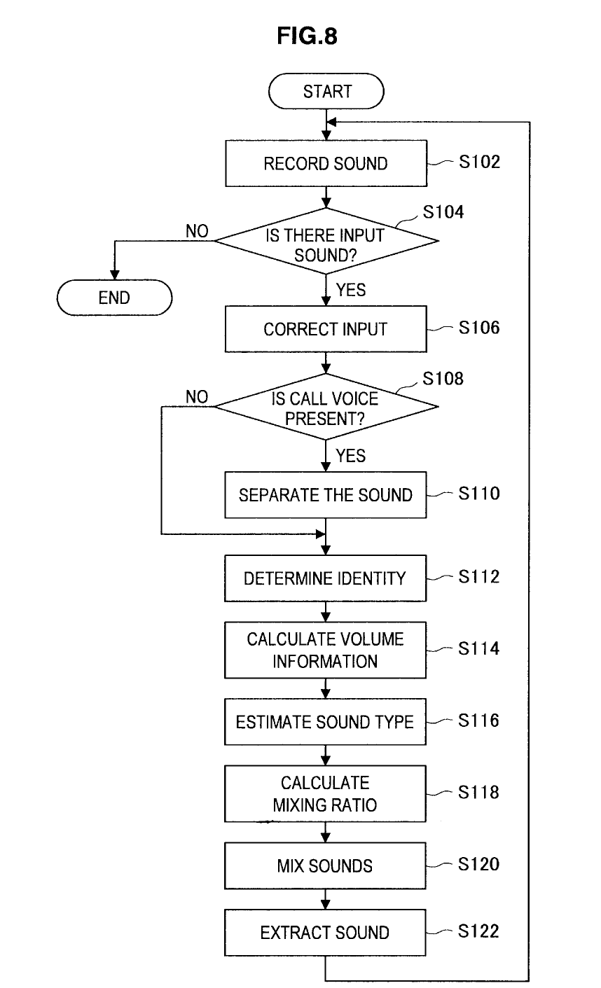

In the foregoing, the functional configuration of the call voice processing apparatus 10 according to the present embodiment has been described. Next, a call voice processing method executed by the call voice processing apparatus 10 will be described with reference to FIG. 8. FIG. 8 is a flow chart showing the flow of the call voice processing method executed by the call voice processing apparatus 10 according to the present embodiment. As shown in FIG. 8, first the first sound recording unit 102 of the call voice processing apparatus 10 records a call voice, which is a first input sound. Then, the second sound recording unit 110 records a sound during imaging, which is a second input sound (S102).

Next, the first sound recording unit 102 determines whether the first sound has been input and also the second sound recording unit 110 determines whether the second sound has been input (S104). If there has been neither first input sound nor second input sound at step S104, processing is terminated.

If the first sound recording unit 102 determines at step S104 that there has been the first input sound, the input correction unit 104 corrects characteristics of the first input sound to those of the second input sound (S106). Next, the sound determination unit 108 determines whether a call voice is present in the first input sound (S108).

If the sound determination unit 108 determines at step S108 that a call voice is present in the first input sound, the sound separation unit 112 separates the second input sound into a plurality of sounds (S110). At step S110, the sound separation unit 112 may separate the input sound in units of blocks of a predetermined length. If the sound determination unit 108 determines at step S108 that a call voice is not present in the first input sound, processing at step S112 is performed without the second input sound being separated.

Then, the identity determination unit 118 determines whether the second input sound separated in units of blocks of a predetermined length at step S110 is identical among a plurality of blocks (S112). The identity determination unit 118 may determine the identity by using the distribution of amplitude information, volume, direction information and the like at discrete times of sounds in units of blocks separated at step S110.

Next, the sound type estimation unit 122 calculates volume information of each block (S114) to estimate the sound type of each block (S116). At step S116, the sound type estimation unit 122 separates the sound into a voice uttered by the operator, sound caused by an object, noise resulting from an operation of the operator, impulse sound, steady environmental sound and the like.

Next, the mixing ratio calculation unit 120 calculates a mixing ratio of each sound in accordance with the sound type estimated at step S116 (S118). The mixing ratio calculation unit 120 calculates a mixing ratio that reduces the volume of a dominant sound based on volume information calculated at step S114 and sound type information calculated at step S116.

Then, the plurality of sounds separated at step S110 is mixed using the mixing ratio of each sound calculated at step S118 (S120). In the foregoing, the sound separation method executed by the call voice processing apparatus 10 has been described. A call voice is extracted from the first input sound corrected at step S106 using a mixed sound mixed at step S120 (S122).

According to the above embodiment, as described above, characteristics of the first input sound input from a call microphone are corrected to those of the second input sound input from an imaging microphone. The second input sound is separated into sounds caused by a plurality of sound sources and a plurality of separated sound types is estimated. Then, a mixing ratio of each sound is calculated in accordance with the estimated sound type and each separated sound is remixed in the mixing ratio. Then, a call voice is extracted from the first input sound whose characteristics have been corrected using a mixed sound after being remixed.

Accordingly, a call can be made comfortably by extracting a call voice from the first input sound input into a call microphone by utilizing an imaging microphone provided with the call voice processing apparatus 10. For example, an appropriate call can be prevented from being disabled after a desired call voice is made harder to hear by being masked by noise whose volume is higher than that of the call voice. Also, a call voice desired by the user can be extracted by utilizing the imaging microphone without a microphone to collect or remove an environmental sound being added to the call voice processing apparatus 10.

### [3] Description of the Call Voice Processing Apparatus According to a Second Embodiment of the Present Invention

In the first embodiment, as described above, the second input sound is separated into sounds and then the separated second input sounds are remixed. In the second embodiment, however, the first input sound as well as the second input sound is used to separate the input sound. Therefore, the extraction unit 106 extracts a call voice by using a mixed sound including the first input sound. A portion of the second embodiment that is different from the first embodiment will be described particularly in detail and a detailed description of components similar to those in the first embodiment is omitted.

### [3-1] Functional Configuration of the Call Voice Processing Apparatus According to the Present Embodiment

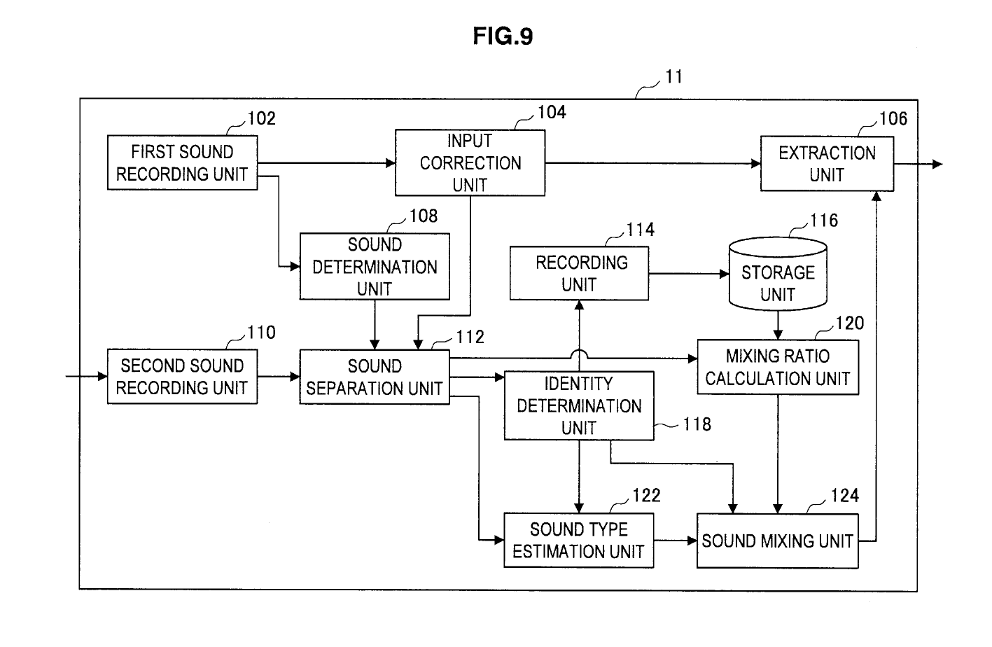

The functional configuration of a call voice processing apparatus 11 according to the present embodiment will be described with reference to FIG. 9. As described above, the call voice processing apparatus 11 according to the present embodiment separates the input sound using both the first input sound input from a call microphone and the second input sound input from an imaging microphone.

As shown in FIG. 9, the call voice processing apparatus 11 includes the first sound recording unit 102, the input correction unit 104, the extraction unit 106, the sound determination unit 108, the second sound recording unit 110, the sound separation unit 112, the recording unit 114, the storage unit 116, the identity determination unit 118, the mixing ratio calculation unit 120, the sound type estimation unit 122, and the sound mixing unit 124.

The input correction unit 104 provides a corrected first input sound to the sound separation unit 112. Then, the sound separation unit 112 separates the input sound using not only the second input sound provided by the second sound recording unit 110, but also the first input sound provided by the input correction unit 104.

The extraction unit 106 extracts a call voice by emphasizing call voice components in the remixed input sound.

Also in the present embodiment, a configuration in which the function of the sound determination unit 108 is omitted may be adopted. That is, the input sound including all the first input sound and the second input sound may be provided to the sound separation unit 112 without the first input sound being determined.

According to the above embodiment, as described above, characteristics of the first input sound input from a call microphone of the call voice processing apparatus 11 are corrected to those of the second input sound input from an imaging microphone. The second input sound and the corrected first input sound are separated into sounds caused by a plurality of sound sources and a plurality of separated sound types is estimated. Then, a mixing ratio of each sound is calculated in accordance with the estimated sound type and each separated sound is remixed in the mixing ratio. Then, a call voice is extracted from a mixed sound after being remixed.

Accordingly, a call can be made comfortably by extracting a call voice from the first input sound input into a call microphone by utilizing an imaging microphone provided with the call voice processing apparatus 11. For example, an appropriate call can be prevented from being disabled after a desired call voice is made harder to hear by being masked by noise whose volume is higher than that of the call voice. Also, a call voice desired by the user can be extracted by utilizing the imaging microphone without a microphone to collect or remove an environmental sound being added to the call voice processing apparatus 11.

It should be understood by those skilled in the art that various modifications, combinations, sub-combinations and alterations may occur depending on design requirements and other factors insofar as they are within the scope of the appended claims or the equivalents thereof.

In the above embodiment, for example, improvement of quality of a call voice in a communication apparatus having an imaging function is described, but the present invention is not limited to such an example. For example, the communication apparatus may have a recording function, though an imaging function is not provided. The above invention may be applied to a communication apparatus having, in addition to a call microphone, an available additional microphone.

The present application contains subject matter related to that disclosed in Japanese Priority Patent Application JP 20xx-xxxxxx filed in the Japan Patent Office on xx(day) xxxx(month) 20xx, the entire content of which is hereby incorporated by reference.

What is claimed is:

1. A call voice processing apparatus, comprising:
an input correction unit that corrects characteristics of a first input sound input from a first input apparatus to characteristics of a second input sound input from a second input apparatus that are different from the characteristics of the first input sound;
a sound separation unit that, when a plurality of sounds is contained in the second input sound, separates the second input sound into a plurality of sounds;
a sound type estimation unit that estimates sound types of the plurality of sounds separated by the sound separation unit;
a mixing ratio calculation unit that calculates a mixing ratio of each sound in accordance with the sound type estimated by the sound type estimation unit;
a sound mixing unit that mixes the plurality of sounds separated by the sound separation unit in the mixing ratio calculated by the mixing ratio calculation unit; and
an extraction unit that extracts a specific sound from the first input sound corrected by the input correction unit using a mixed sound mixed by the sound mixing unit.

2. The call voice processing apparatus according to claim 1, wherein the first input apparatus is a call microphone and the second input apparatus is an imaging microphone, and
the specific sound extracted by the extraction unit is a voice of a caller.

3. The call voice processing apparatus according to claim 1, wherein the sound separation unit
separates the first input sound and the second input sound into a plurality of sounds.

4. The call voice processing apparatus according to claim 1, further comprising:
a sound determination unit that determines whether the first input sound contains a voice of a caller.

5. The call voice processing apparatus according to claim 4, wherein the sound determination unit
determines whether a sound source of a caller is contained by determining a direction of the sound source, a distance, and a tone using at least one of a volume of the input sound, a spectrum, a phase difference of a plurality of input sounds, and a distribution of amplitude information at discrete times.

6. The call voice processing apparatus according to claim 1, wherein the input correction unit corrects frequency characteristics of the first input sound and/or the second input sound.

7. The call voice processing apparatus according to claim 1, wherein the input correction unit performs sampling rate conversions of the first input sound and/or the second input sound.

8. The call voice processing apparatus according to claim 1, wherein the input correction unit corrects a delay difference due to A/D conversions of the first input sound and/or the second input sound.

9. The call voice processing apparatus according to claim 1, wherein
the sound separation unit separates the input sound into a plurality of sounds in units of blocks, comprising:
an identity determination unit that determines whether the sounds separated by the sound separation unit are identical among a plurality of blocks; and
a recording unit that records the sounds separated by the sound separation unit in units of blocks.

10. The call voice processing apparatus according to claim 1, wherein the sound separation unit separates the input sound into a plurality of sounds using statistical independence of sound and differences in spatial transfer characteristics.

11. The call voice processing apparatus according to claim 1, wherein the sound separation unit separates the input sound into a sound originating from a specific sound source and other sounds using a paucity of overlapping between time-frequency components of sound sources.

12. The call voice processing apparatus according to claim 1, wherein the sound type estimation unit estimates whether the input sound is a steady sound or non-steady sound using a distribution of amplitude information, direction, volume, zero crossing number and the like at discrete times of the input sound.

13. The call voice processing apparatus according to claim 11, wherein the sound type estimation unit estimates whether the sound estimated to be a non-steady sound is a noise sound or a voice uttered by a person.

14. The call voice processing apparatus according to claim 11, wherein the mixing ratio calculation unit calculates a mixing ratio that does not significantly change the volume of the sound estimated to be a steady sound by the sound type estimation unit.

15. The call voice processing apparatus according to claim 12, wherein the mixing ratio calculation unit calculates a mixing ratio that lowers the volume of the sound estimated to be a noise sound by the sound type estimation unit and does not lower the volume of the sound estimated to be a voice uttered by a person.

16. A call voice processing method, comprising the steps of:
correcting characteristics of a first input sound input from a first input apparatus to characteristics of a second input sound input from a second input apparatus that are different from the characteristics of the first input sound;
when a plurality of sounds is contained in the second input sound, separating the second input sound into a plurality of sounds;
estimating sound types of the plurality of separated sounds;
calculating a mixing ratio of each sound in accordance with the estimated sound type;
mixing the plurality of separated sounds in the calculated mixing ratio; and
extracting a specific sound from the corrected first input sound using a mixed sound obtained by the mixing.

17. A program for causing a computer to function as
a call voice processing apparatus, comprising:
an input correction unit that corrects characteristics of a first input sound input from a first input apparatus to characteristics of a second input sound input from a second input apparatus that are different from the characteristics of the first input sound;
a sound separation unit that, when a plurality of sounds is contained in the second input sound, separates the second input sound into a plurality of sounds;
a sound type estimation unit that estimates sound types of the plurality of sounds separated by the sound separation unit;
a mixing ratio calculation unit that calculates a mixing ratio of each sound in accordance with the sound type estimated by the sound type estimation unit;
a sound mixing unit that mixes the plurality of sounds separated by the sound separation unit in the mixing ratio calculated by the mixing ratio calculation unit; and
an extraction unit that extracts a specific sound from the first input sound corrected by the input correction unit using a mixed sound mixed by the sound mixing unit.
